(19) United States
(12) Patent Application Publication
(10) Pub. No.: US 2006/0026009 A1
(43) Pub. Date: Feb. 2, 2006

(54) Systems and methods for selecting and prioritizing construction checkpoints

(76) Inventor: Stanley R. Luhr, El Cajon, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/900,734

(22) Filed: Jul. 28, 2004

(51) Int. Cl. G06Q 99/00

(52) U.S. Cl. 705/1; 705/9

(57) ABSTRACT

The computer-based system described herein accepts information about a building project and uses the information to select from a repository of construction checkpoints a subset of the checkpoints that are deemed to be relevant to improve a building's safety, durability and comfort and to reduce financial risk. The checkpoints may be selected and/or prioritized for viewing by an inspector inspecting the building project based on at least one of: project geographic location, project-specific exposure, type of structure, complexity of building components, product quality, builder's repeated deficiencies, and codes and specifications. The system may further be configured to receive information about a current stage of construction of the building project and to present checkpoints to the inspector that are relevant to the current stage of construction. The system may also be configured to prioritize presentation of selected checkpoints based at least in part on an assessment of financial risk posed by improper installation and/or construction of the selected checkpoints. In various embodiments, checkpoints that do not pass inspection may be tracked until repaired, and a record of the repair may be stored for later verifying that the error was repaired and not ignored.

### FIELD OF THE INVENTION

The invention relates to computer-implemented methods for the selection and presentation of checkpoints used to inspect construction projects.

### BACKGROUND OF THE INVENTION

Construction of, and improvements to, industrial, commercial, and residential real property has grown to involve billions of dollars in annual sales. Recently, there has also been an increase in associated construction defect litigation. Such litigation often relates to deficiencies that are caused by errors in simple building practices, such as mis-lapped building paper or reversed lap membranes which may allow a leak and an eventual growth of mold in a structure. These types of errors can typically be most effectively and inexpensively resolved at the time of construction, if they are identified in a timely manner.

Construction inspection checklists are commonly used to identify deficiencies during construction, but defects continue to occur for a variety of reasons. For one thing, thousands of possible checkpoints exist, stemming from building codes and regulations, manufacturers' specifications, and knowledge of past construction-related claims and litigation. Of the thousands of possible checkpoints, not all are equally important to an inspection that aims to minimize a builder's subsequent financial liability, and not all are equally important for every type of building project. Even if several thousand checklist items are generated, there is no practical human method of determining which ones would yield the greatest effectiveness in improving durability, safety, and comfort of a building, since few inspectors possess extraordinary skills across the spectrum of all construction issues.

Commonly, a subset of all possible checkpoints is selected for inspection, with the hope that checkpoints relevant to the type of construction, location of construction, and building materials used, as well as checkpoints associated with potentially high risks of expense and liability, are included in the subset selected for use by the field inspector.

Currently, checkpoints are frequently selected personally by an inspector based on the inspector's specialized knowledge and/or preferences, may be selected based on what is easy to observe, or may even be selected randomly. Proper selection of checkpoints relies on a wealth of knowledge and experience that may not be available to new inspectors, to inspectors unfamiliar with the demands of certain geographic or climate zones, or to inspectors who do not factor. historical construction litigation data into their selection of checkpoints to inspect. Furthermore, the inspector's failure to coordinate with the work schedule of a building project may result in checkpoints that are inspected before they reach a critical stage and/or after they are no longer easily visible due to continuing construction.

In cases where a checkpoint selection/inspection documentation system is used, checkpoints are frequently generated as a fixed set with little, if any, customization for the project at hand. Current inspection practices are of limited value due to these complexities, since few inspectors possess the skills and experience to identify a broad range of construction defects. When defects are identified, they are often hand-written in a negative connotation, and have no factual back-up information for offenders to learn from their mistakes.

For these and other reasons, systems and methods are needed for more systematically selecting checkpoints that can focus a construction site inspection on checkpoints of significance to construction quality and risk avoidance.

### SUMMARY OF THE INVENTION

The present invention addresses these and other problems by providing a computer-based system that accepts information about a building project and uses the information to select, from a repository of construction checkpoints derived from various sources, a subset of the checkpoints that are deemed to be relevant to the building project. The checkpoints may be selected and/or prioritized for viewing by an inspector inspecting the building project based on at least one of: project geographic location, project-specific exposure, type of structure, complexity of building components, product quality, builder's repeated deficiencies, and codes and specifications. The system may further be configured to receive information about a current stage of construction of the building project and to present checkpoints to the inspector that are relevant to the current stage of construction. The system may also be configured to prioritize presentation of selected checkpoints based at least in part on an assessment of financial risk posed by improper installation and/or construction of the selected checkpoints. In various embodiments, checkpoints that do not pass inspection may be tracked until repaired, and a record of the repair may be stored for later verifying that the error was repaired and was not ignored.

An embodiment of a method is described for selecting a subset of construction checkpoints associated with a building project to guide an inspection for reducing financial risk associated with the building project. The method, which is performed by a computer system that implements a repository of construction checkpoints, includes the computer-implemented steps of: receiving from a builder information about a building project; filtering records in a repository of construction checkpoints such that a subset of construction checkpoints relevant for conducting an inspection associated with constructing the building project may be selected, based at least in part on the information about the building project; and presenting at least some of the selected construction checkpoints for use in guiding an inspection of the building project.

An embodiment of a computer-implemented construction checkpoint selection system is described, wherein the system comprises: a user interface for accepting information about a building project, a repository of construction checkpoints, and a checkpoint selection application configured to receive the information about the building project and to use the information to select from the repository a subset of the construction checkpoints for use in inspecting the building project.

An embodiment of a system is described, wherein the system selects from a computer-stored repository of construction checkpoints a subset of the checkpoints for guiding an inspection to minimize financial risk associated with constructing a building project. The system comprises: means for receiving information about a building project from a builder; means for filtering records in a repository of construction checkpoints such that a subset of construction checkpoints relevant for reducing financial risk associated with constructing the building project may be selected, based at least in part on the information about the building project; and means for presenting at least some of the selected construction checkpoints for use in guiding an inspection of the building project.

An embodiment of a computer-implemented method of increasing an effectiveness of building inspections is described. The method comprises the computer-implemented acts of: receiving data descriptive of a building project for which one or more inspections are to be performed, including information about a geographic region of the building project, a current stage of the building project, and types of construction materials used; and programmatically selecting, from a repository of construction checkpoints, a subset of construction checkpoints to use to conduct an inspection associated with the building project, such that the subset of checkpoints is selected based at least in part on the information about the geographic region of the building project, the current stage of the building project, and the types of construction materials used.

For purposes of summarizing the invention, certain aspects, advantages and novel features of the invention have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessarily achieving other advantages as may be taught or suggested herein.

### BRIEF DESCRIPTION OF THE DRAWINGS

A general architecture that implements various features of specific embodiments of the invention will now be described with reference to the drawings. The drawings and the associated descriptions are provided to illustrate embodiments of the invention and not to limit the scope of the invention. Throughout the drawings, reference numbers are re-used to indicate correspondence between referenced elements. In addition, the first digit of each reference number indicates the figure in which the element first appears.

FIG. 1 is a block diagram that depicts a high level view of a system for selecting and prioritizing construction checkpoints.

FIG. 2 is a block diagram that depicts one embodiment of a system for selecting and prioritizing construction checkpoints using checkpoint filters.

FIGS. 3A-3B depict a sample of project set-up screens for obtaining project information from a builder.

FIG. 4 depicts a first screenshot that displays selected construction checkpoints to a field inspector.

FIG. 5 depicts a second screenshot that displays a selected construction checkpoint.

FIG. 6 is a flowchart that depicts a high-level overview of one embodiment of a process to select construction checkpoints.

### DETAILED DESCRIPTION OF THE PREFERRED EMBODIMENT

Computer-implemented systems and methods for selecting and prioritizing construction checkpoints will be described. As used herein, the term “construction checkpoint” refers to a description, which may be part of an inspector checklist, of a construction element to be checked as part of an on-site inspection. A checkpoint is preferably a positively-worded statement that assists one in determining if a construction element, such as a product, component, or system, is of good quality and functional for its intended purpose. For example, “Shear wall fasteners are set flush to the diaphragm” identifies the quality intent, instead of negative statements such as “Shear wall fasteners are ovemailed.” Typically, each checkpoint corresponds to a particular construction element.

A repository of information about construction checkpoints may comprise, among other types of information, data about correct construction practices associated with the checkpoints and conditions under which the various checkpoints may be relevant to construction quality. For example, checkpoints for inspecting construction elements associated with building a basement are not relevant to the construction of a home with no basement. Furthermore, certain checkpoints may be more relevant where weather conditions are frequently damp, prone to temperature extremes over the year, or susceptible to wind or earthquakes. Information about checkpoints may also comprise an assessment of potential financial risk associated with a construction element that is improperly installed or constructed, and other information associated with construction elements, as is described in greater detail herein.

The computer-based system described herein accepts information about a building project and uses the information to select from the repository of construction checkpoints a subset of the checkpoints that are deemed to be relevant to the building project. The system may further be configured to receive information about a current stage of construction of the building project and to present checkpoints to the inspector that are relevant to the current stage of construction. The system may also be configured to prioritize presentation of selected checkpoints based at least in part on an assessment of financial risk posed by improper installation and/or construction of the selected checkpoints. The selected subset of construction checkpoints may be presented to an inspector inspecting the building project. In some embodiments, the checkpoints may assist the inspector in identifying and tracking construction elements that have passed inspection, and may therefore be considered “closed,” as well as those that have not yet passed inspection and are therefore considered “open.”

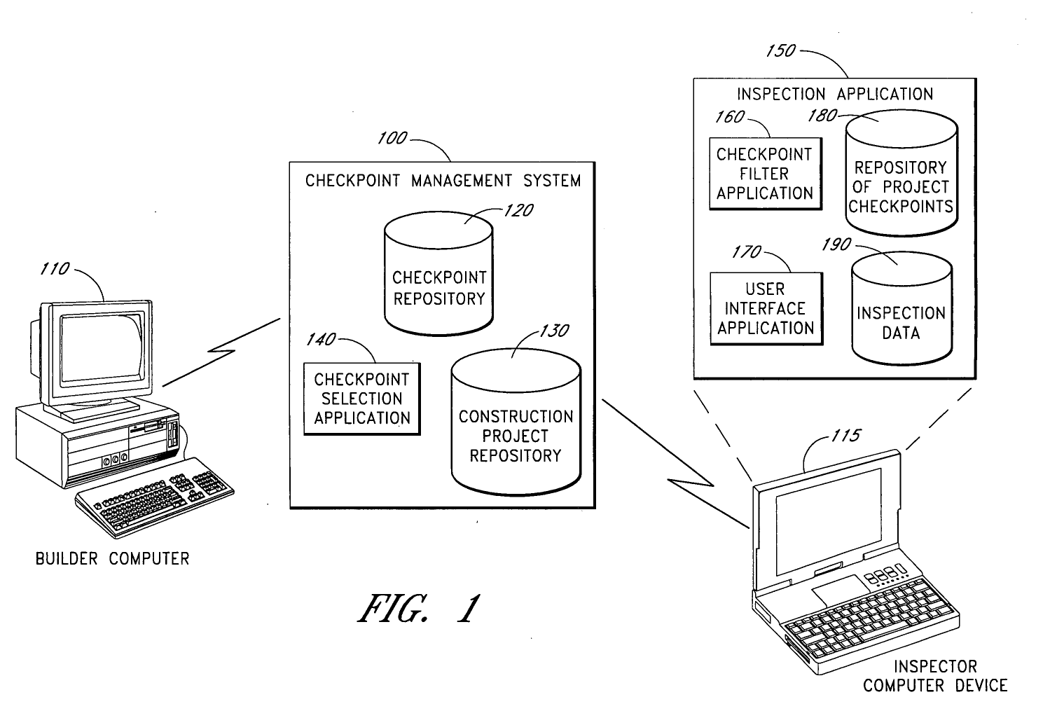

FIG. 1 is a block diagram that depicts a high level view of one embodiment of a system for selecting and prioritizing construction checkpoints. As depicted in FIG. 1, the system may comprise a checkpoint management system 100 that receives information about a building project from a builder via a builder computer 110, and that selects from a repository of checkpoint information 120 a subset of checkpoints that are relevant to the building project. In some embodiments, the builder computer 110 may further pass information to the checkpoint management system 100 from the builder regarding the builder's preferences with regard to the selection of checkpoints associated with the builder's project. For example, the builder may send via the builder computer 110 information about a preferred scope and/or number of inspections to be performed for the project. Thus, a builder desiring inspections to be performed once weekly due, for example, to rapid construction progress may prefer to utilize checkpoints representing a higher associated level of financial risk if improperly constructed. In other embodiments, other opportunities for the builder computer 110 to be used to communicate the builder's desire for a customized set of construction checkpoints may be implemented.

The checkpoint management system 100 described herein preferably selects and/or filters checkpoints based on a plurality of variables, including, for example, past performance, geography, jobsite schedule, and building risk. Builders attempting to select checkpoints on their own may not be equipped to select similarly high-risk checkpoints due to their inexperience.

The checkpoint management system 100 may be configured to run on one or more computers that are networked together. Thus, various components and the various functions carried out by the checkpoint management system 100 may be executed in-whole or in-part on computers that may be located at one location or at a plurality of locations.

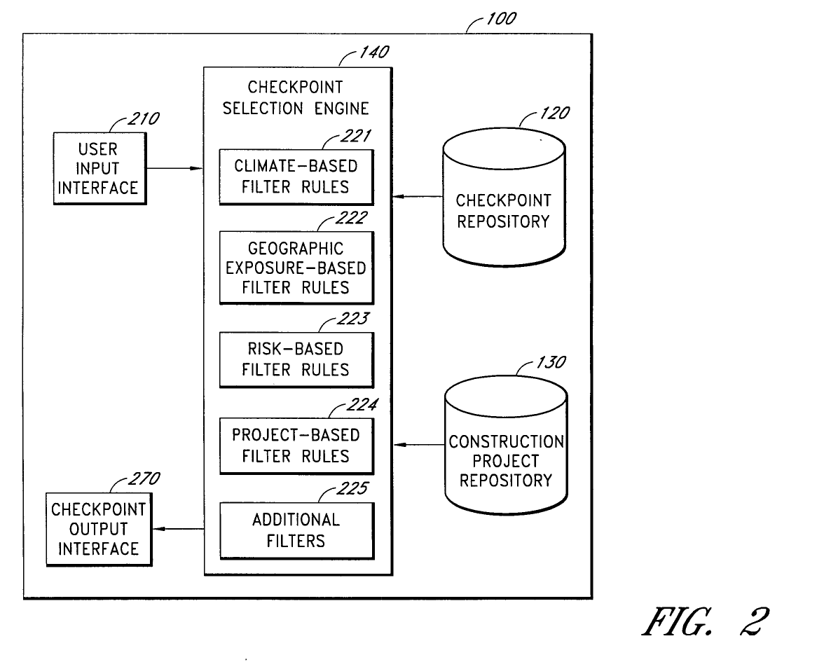

The checkpoint management system 100 may store the information about the building project in a construction project repository 130. As will be described in greater detail with reference to FIG. 2, a checkpoint selection engine 140 in the checkpoint management system 100 uses the information about the building project to select the subset of checkpoints that are relevant to the building project.

The checkpoint management system 100 may be configured to run on a computer that is in communication with the builder computer 110 via the Internet or other computer network. In other embodiments, information about the building project may be received from the builder by another method, such as on paper in a natural or machine-readable language, via telephone, or from an in-person interview, and the information may be entered into one or more checkpoint management system 100 computers using any of a variety of input methods, such as manual keyboard input, voice recognition software, optical character recognition, or other machine-reading technology.

As further depicted in FIG. 1, the checkpoint management system 100 may transmit to an inspector computer device 115 the selected subset of checkpoints for the building project so that an inspector may use the transmitted construction checkpoints to guide one or more inspections of the building project. The task of selecting the subset of checkpoints may alternatively be performed in-whole or in-part by software executed on the inspector computer device 115.

The inspector computer device 115 may be a portable computer device such as a laptop or notebook computer or a personal digital assistant (PDA) that the inspector may take on the inspections. In a preferred embodiment, the inspector computer device 115 is a specially constructed shock-resistant notebook computer with a built-in camera that can photograph a construction element that corresponds to an inspected checkpoint to provide photo-verification of the construction conditions reported by the inspector.

Communications between the checkpoint management system 100 and the inspector computer device 115, including transferring the set of checkpoints selected by the checkpoint selection engine 140 to the inspector computer device 115, may be implemented using a variety of different communications methods. In one embodiment, the inspector computer device 115 may be brought, for example, to a central office and may be physically connected to the computer running the checkpoint management system 100 for downloading the subset of construction checkpoints selected by the checkpoint management system 100 and may then be taken to one or more remote building sites for conducting one or more inspections. In another embodiment, the checkpoint management system 100 transmits the selected subset of construction checkpoints to a personal computer (PC) or other computer situated at the building site, such as to a superintendent's onsite office. The inspector computer device 115 may be physically connected to the building site computer in order to download the selected construction checkpoints. In another embodiment, the inspector computer device 115 is configured to communicate with the checkpoint management system 100 using a wireless communications technology. In other embodiments, other technologies are used to pass the selected subset of checkpoints to the inspector computer device 115. A common transfer mechanism uses the Internet or other computer network, with the inspector computer device 115 attached, for example, nightly, to a computer network at the inspector's home or office. Further, the system may support two or more of the foregoing options to provide flexibility to the inspector.

In the embodiment depicted in FIG. 1, the inspector computer device 115 is configured to run an inspection application 150 that receives the selected subset of checkpoints for the building project from the checkpoint management system 100 and that stores the checkpoints in a local repository of project-specific checkpoints 180. The inspection application 150 may be further configured to run a checkpoint filter application 160 that selects from the checkpoints in the repository of project checkpoints 180 a subset of checkpoints to present to the inspector via a user interface 170. For example, the checkpoint filter application 160 may be configured to receive from the inspector, via the user interface 170, information about a current stage of construction that the inspector desires to inspect, and based at least in part on the received information, the checkpoint filter application 160 may select project-specific checkpoints that are relevant to the current stage of construction for presentation to the inspector. In this way, the inspector may be reminded to inspect checkpoints that are relevant to financial risk reduction and quality assurance for the building project during a time period when the checkpoint may be visually observed and, if necessary, repaired before being obscured by subsequent construction. If the portable device 115 maintains a wireless link to the checkpoint management system 100, the checkpoint filtering task may alternatively be performed by the checkpoint management system 100.

The inspection application 150 may further include a repository of inspection data 190 for storing information about the inspections, such as which checkpoints have been inspected, when and by whom, which inspected checkpoints have been deemed acceptable and which need correction, associated documentation, such as authenticating photographs, and the like. The inspection data 190, or a portion thereof, may be transmitted to the checkpoint management system 100 and may be communicated by the management system 100 to the builder.

For example, as will be described in greater detail below, input of data regarding an inspection of a construction element corresponding to a given checkpoint may signal arrival at a particular stage of construction or percentage of construction completed. A subset of the checkpoints in the repository 120 may contain information linking the checkpoints to construction progress, and thereby allowing the system 100 to automatically track and calculate a job's percentage-of-completion, critical path, and progress, saving time and avoiding duplication.

In some embodiments, in addition to guiding an inspector to inspect construction elements associated with the checkpoints in order to address quality, risk, comfort, and durability issues, the inspection application 150 may direct the inspector, building superintendent, or other builder representative to gather data about construction components observed at the building site, such as information about products and manufacturers installed or to be installed, serial numbers, model numbers, quantities and the like. For example, the inspector computer device 115 may be configured to operate in association with a scanning device or other device capable of electronically reading and inputting a bar code or other identifying information from a building component observed by the inspector. Other data may be manually input by the inspector or superintendent. The input data may be passed by any of the communications methods described above to the checkpoint management system 100, which may, in turn, transmit some or all of the information to the builder, to insurance or warranty companies, to product vendors, or to other interested parties. Alternatively, the inspection application 150 on the inspector computer device 115 may be configured to communicate directly with interested parties, again through any one or more of a variety of possible communications channels.

For example, a manufacturer who is electronically provided with information about building components observed at the building site may provide additional information directly (for example, via wireless computer and/or telephone methods) to the inspector or end user, such as installation modifications or warnings not previously included in product packaging.

The information thus gathered at the building site may be used to create a profile that documents components used in the construction of a home or other structure. Such a profile may be valuable to an eventual homeowner for maintenance, insurance, resale, as well as other purposes. The information thus gathered may also be of value to vendors who typically have difficulty tracking the eventual locations and owners of their products. Vendors may use the information to provide targeted information to homeowners and the like regarding maintenance and other updates, product recalls and warnings, promotional offers, and the like, as well as using the information for marketing and research purposes. In some embodiments, vendors who receive electronic notification of the installation of one of their products in the field may be able to transmit information, either directly or via the checkpoint management system 100, to the inspector computer device 115 regarding step-by-step installation guidance, updated installation advisories, or other information useful to an inspector or to a tradesman in the field.

In various embodiments, differing portions of the systems and methods for selecting and prioritizing construction checkpoints may be implemented by the checkpoint management system 100 and by the inspection application 150. For example, in a preferred embodiment, the checkpoint management system 100 selects from the checkpoint repository 120 the checkpoints that are relevant to the structure-type and location of the building project, and transmits the full set of selected checkpoints to the inspection application 150. The checkpoint filter application 160 then selects and prioritizes a subset of the received checkpoints for presentation to the inspector at a given inspection. For example, the selection and prioritization of checkpoints for a given inspection may be based at least in part on one or more of: current stage of construction, relative financial risk associated with the relevant checkpoints, amount of time available to the inspector for performing the inspection, and/or other special instructions received from the builder. In such an embodiment, the full set of selected project-specific checkpoints may be available to the inspector in addition to, or as an alternative to, the checkpoints presented by the inspection application 150. Thus, the inspector may respond to conditions noted at the inspection site, such as a checkpoint that is not presented but that the inspector notes is in need of correction. Furthermore, in some embodiments, the inspector computer device 115 may only be in direct contact with the checkpoint system 100 one time in order to download a full set of checkpoints for the duration of the building project.

In other embodiments, more of the selection and prioritization may be carried out by the checkpoint management system 100. For example, the checkpoint management system 100 may be configured to select a small subset of checkpoints, such as ten checkpoints, to be inspected by the inspector or jobsite superintendent during a given abbreviated inspection of the building project. The checkpoint management system 100 may communicate the small subset of checkpoints to the inspector computer device 115 on a daily basis or as inspections are conducted. In other embodiments, the inspection application 150 and the checkpoint management system 100 may be configured to each implement different portions of the systems and methods for selecting and prioritizing construction checkpoints. Thus, it should be understood that the checkpoint selection tasks herein need not be performed in any particular location or set of locations.

Although FIG. 1 depicts a one-to-one relationship between builder computer 110 and the checkpoint management system 100, a many-to-one relationship may exist, with many builder computers 110, representing many builders, communicating to the checkpoint management system 100 to request a set of customized construction checkpoints for one or more of their building projects. Similarly, although a one-to-one relationship is depicted between the checkpoint management system 100 and the inspector computer device 115, a one-to-many relationship will typically exist, with the checkpoint management system 100 providing sets of checkpoints for a plurality of inspector computer devices 115.

For example, one inspector may inspect a plurality of building projects. The building projects may be associated with a single builder. Alternatively, at least two of the building projects may be associated with different builders. The inspection application 150 running on a single inspector computer device 115 may be configured to manage checkpoints and inspection data for a plurality of building projects, keeping separate the repositories of project-specific checkpoints 180 and the repositories of inspection data 190 for the various building projects.

FIG. 2 is a block diagram that depicts one embodiment of the checkpoint management system 100. As was described with reference to FIG. 1, portions of the systems and methods for selecting and prioritizing construction checkpoints may be implemented with the checkpoint selection engine 140 of the checkpoint management system 100 and within the checkpoint filter application 160 of the inspection application 150. For ease of description, the embodiment of the checkpoint selection engine 140 depicted in FIG. 2 includes selection and prioritization functions that may, in other embodiments, be implemented by the checkpoint filter application 160.

The checkpoint management system 100 of FIG. 2 comprises a checkpoint selection engine 140 that may receive input from a user input interface 210, from the checkpoint repository 120 and from the construction project repository 130. The checkpoint selection engine 140 may output a set of selected checkpoints using a checkpoint output interface 270.

Information about a building project may be received from a builder, as was described with reference to FIG. 1. The user input interface 210 in the checkpoint management system 100 may receive input from the builder computer 110 and may pass the information to the checkpoint selection engine 140 for the selection of a set of checkpoints that are customized to the building project. Additionally or alternatively, information about the building project, including information received from the builder and information received from ongoing inspections of the project, may be stored in the construction project repository 130 in association with the project and may be used by the checkpoint selection engine 140 for the selection from the checkpoint repository 120 of a set of checkpoints that are customized to the building project.

The checkpoint repository 120 may be organized as a database of records that store information about individual checkpoints. A record about an individual checkpoint may include fields that store: information to identify the checkpoint, information to direct an inspector to examine one or more examples of the checkpoint, and a description of correct installation and/or construction methods associated with the checkpoint. In various embodiments, a record in the checkpoint repository 120 may include additional information, such as information for use in selecting checkpoints that are appropriate to a given construction project at a given point in its progress towards completion, and/or supplemental explanatory information about the checkpoint for use by the inspector. For example, the checkpoint repository 120 may include data about historical failures, construction defect claims, litigation history, manufacturer-specific as well as instructions or alerts associated with the various checkpoints.

The following list provides a sampling of some of the types of fields that may be used in various embodiments of the checkpoint repository 120:

Identification: One or more fields may store information used to identify and/or categorize the checkpoint. A checkpoint identification number and/or checkpoint name may be assigned to the checkpoint. The checkpoint may also be categorized at one or more levels of construction system granularity. For example, the checkpoint may be categorized on the system level as to whether the checkpoint refers to part of the building's foundation, exterior, roofing, plumbing, or thermal systems, and so forth. The checkpoint may be further categorized on the subsystem level. For example, checkpoints identified as pertaining to the foundation system may be divided further by foundation type and may be further categorized as relating to concrete, footings, or rebar used as part of the foundation. A further categorization may include a specific product or methodology employed for that purpose, wherein specific risks are identified as being so unique as to apply only to that subset. In various embodiments, checkpoints may be additionally categorized down to a subsystem component level or other more granular level of categorization. With regard to some checkpoints, the level of granularity may extend down to categorization by manufacturer of the component, when significant differences exist amongst the products or risks associated with various manufacturers. Categorization may further include make, model, or product type of various components used in a building. Other systems for organizing and categorizing records in the checkpoint repository 120 may also be included for use in selecting one or more checkpoints.

Instruction: One or more fields of the checkpoint record may store information used to instruct an inspector or other recipient of the checkpoint information as to correct construction methodology associated with the checkpoint. A checkpoint description field may describe how to determine whether the subject of the checkpoint has been properly constructed and may instruct an inspector using positively-worded descriptions, such as (for a checkpoint for exterior cement plaster stucco), “Stucco soffits less than 2-feet wide have continuous building paper overlapped at least 2-inches to wall below, or terminated onto drip edge metal.” In some embodiments, additional information may be available to an inspector who wishes to learn more about the checkpoint instruction, such as: associated building codes and other reference citations that provide source information for the checkpoint record, consequences of improper installation or construction practice, stage-of-completion of a building project at which inspection is typically relevant, and so forth.

Climate/Geography/Exposure Zones: One or more fields of the checkpoint record may store information to help classify the checkpoints according to building conditions under which they are most relevant to an inspection that is aimed at ensuring building quality and reducing builder risk. This aspect of the checkpoint selection and prioritization system takes into account the fact that some construction elements are more relevant in one climate or geographic zone than in another. For example, one or more fields may identify whether a checkpoint represents a high level of risk (and associated relevance), in high-moisture areas or in areas that experience extreme temperature fluctuations over the course of the year. In some embodiments, a set of exposure zones are defined and identified by name, such as Hot-Dry, Hot-Humid, Mixed-Humid, Mixed-Dry, Cold, Very Cold, or by number (1-6), and checkpoints are listed as being more relevant or less relevant to construction projects within those zones. In other embodiments, zones may be defined and identified in other ways, as will be familiar to those of ordinary skill in the art.

In addition to exposure zones based on temperature and humidity, additional zones may be defined to identify other types of exposure that are relevant to selection of construction checkpoints. For example, in areas prone to earthquakes, earthquake-related checkpoints are relevant to inspections, while the same checkpoints may not be as relevant in other locations. Exposure to tornados, frequent sand storms, firestorms, and flooding are examples of other types of exposure zones that may be defined and that may be used to categorize and select the checkpoints in the repository 120. It is anticipated that use of the system will allow an automatic generation of exposure- and climate-related risk based on zip code.

Building Type/Material Type: One or more fields of the checkpoint record may store information to help classify the checkpoints according to the type of building and the types of building materials for which they are most relevant. For example, whether a building to be inspected is a single-family dwelling or a multi-family dwelling, whether it is a high-rise or a single-floor building, and whether it will have a steel-clad exterior, concrete, stucco, or glass, may influence the relative relevance of the various checkpoints to the inspection. Furthermore, certain building materials, and, in some cases, certain manufacturers of building materials are known to be subject to construction checkpoint errors, which can be listed in the associated checkpoint records to signal relevance to projects using the materials.

Cost/Risk: One or more fields of the checkpoint record may store information usable by the selection system to help prioritize checkpoint items based on the cost and/or the risk involved if the checkpoint construction item is improperly installed. For example, the checkpoint repository 120 may include one or more fields that store information about a typical cost of repair if the checkpoint is improperly installed. The checkpoint repository 120 may include one or more fields that store information about a historical frequency of construction litigation cases involving the checkpoint and/or about a likelihood that an improperly installed checkpoint item will be discovered and will lead to a claim against the builder. Using these and other associated types of information, the checkpoint selection and prioritization system may present to a building site inspector an ordered set of checkpoints that presents checkpoints associated with greater financial risk first so that the inspector's time may be used more productively.

Milestone/Stage-of-Completion: One or more fields of the checkpoint record may store information that correlates successful inspection and closure of a checkpoint with an associated stage of project completion. In some embodiments, stage-of-completion information may be included in only a subset of the checkpoints whose associated construction elements are deemed to be characteristic of a given stage of construction completion, which may be tracked on a per-unit as well as a per-project basis. In some embodiments, stage of project completion may be expressed as a percentage or range of percentages of the total project completed. In other embodiments, projects may be divided into several known stages of completion, which may be identified by name (for example, Excavation, Foundation, or Exterior Cladding), by number, or by other identification system. Such stages may be mutually exclusive or may allow for some overlap of stages. Checkpoint records may correlate the checkpoint with a specific percentage of project completion or construction stage, or may correlate the checkpoint with a broader designation, such as a range of percentages. This broader representation reflects the fact that the order of installation of some construction elements provides for a degree of builder discretion and flexibility.

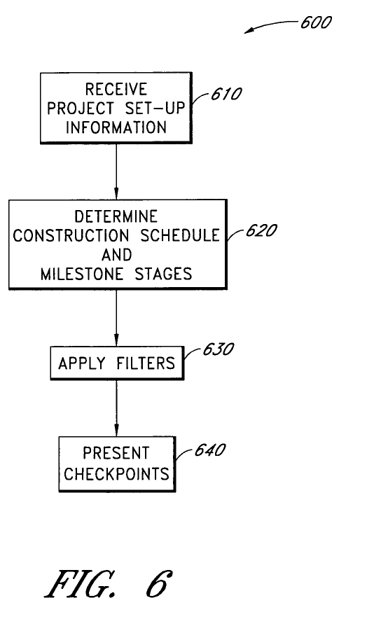

As will be described in greater detail with reference to FIG. 6, identification of a given construction stage may influence selection of associated checkpoints by the checkpoint selection application 140,160. Successful closure of a checkpoint item by an inspector at a building site may conversely, in some embodiments, trigger notification to the system 100 that a given construction stage has been reached or completed. For example, the checkpoint management system 100 may programmatically determine a current stage-of-completion of a building project based on a highest percentage or most advanced construction stage associated with checkpoints that have been successfully inspected and closed by an inspector. In other embodiments, stage-of-completion information may be extracted from the checkpoints using another method. In some embodiments, stage-of-completion information may be determined and stored on both a unit-basis and a project-basis.

Stage-of-completion information generated by information inputted into an inspector computer device 115 may be transmitted to the checkpoint management system 100 using one or more of the communications methods described with reference to FIG. 1, or an equivalent thereof. Alternatively, the inspector computer device 115 may be configured to use the inputted information to determine current stage-of-completion information and to communicate directly with one or more other parties interested in and authorized to receive the information. Stage-of-completion information may be of value to a project manager who is responsible for keeping the building project on track, for providing accurate and up-to-date information to sales personnel, to subcontractors and vendors, government officials, and the like. Stage-of-completion information may also be of relevance with regard to lending and insurance issues, wherein attainment of a given stage-of-completion may, for example, trigger payment of a loan installment or signal need to pay an insurance premium. Using the checkpoint system to determine a current stage-of-completion and to automatically trigger notification of same to relevant parties may obviate a need for “bank draw inspections” or other similar in-person inspections or requests for paperwork to identify a current stage of project completion.

Practitioners familiar with the design and use of databases and other computer-based information repositories will understand that a variety of different data structure configurations and data organization methods may serve to allow retrieval of checkpoints based on building type, geographic location, construction exposure zones, building materials and the like. For example, a binary field may be defined that allows for storage of a binary variable indicating on a yes/no basis whether the checkpoint is relevant to inspections performed, for example, within the area of a given exposure zone. Alternatively, a field for a given exposure zone or other category within the checkpoint record may store a value from a numerical range that may indicate a measure of relevance of the checkpoint with respect to the given exposure zone or category. In other embodiments, a field in the checkpoint's record may list zones and/or categories for which the checkpoint is relevant. Queries to the database may then be designed to select records that indicate relevance to the given exposure zone.

Furthermore, in some embodiments, information stored in the checkpoint repository 120 may be dynamically updated in response, for example, to information from construction defect litigation cases and insurance claims, in response to inspection results that may point out frequently occurring inspection failures, or in response to newly available information from construction industry sources and/or construction product manufacturers.

The checkpoint selection engine 140 may be implemented as sets of filter rules 221-225 for processing the contents of the checkpoint repository 120 in order to select checkpoints relevant to the building project. Climate-based filter rules 221 scan the contents of the checkpoint repository 120 to select checkpoints that may be of more relevance to projects built in a climate zone associated with the building project. In one embodiment, building projects in the United States and Canada are categorized into one of six climate zones, and checkpoint records in the repository 120 include an indication as to one or more climate zones in which incorrect construction practices associated with the checkpoint may impact construction quality. In addition, an exposure-based filter may be employed to identify checkpoints based on micro-climate influences such as exposure to marine-laden air, urban heat-island effects, lakeshore effects, pollution, and the like.

Geographic exposure-based filter rules 222 similarly provide rules for scanning the checkpoint repository 120 to identify and select checkpoints of relevance to building projects in areas that are exposed to one or more of a variety of environmental conditions which are not addressed by the climate-based filter rules 221. For example, areas known to be subject to earthquakes, forest fires, frequent sandstorms, coastal salt-air corrosion, expansive soil, extreme altitude, and additional or alternative environmental conditions that impact construction quality and subsequent financial risk may be identified and used to select checkpoints for a given building project.

Risk-based filter rules 223 make use of historical information stored in the records of the checkpoint repository 120 to identify checkpoints that have historically been associated with claims against builders and with associated financial risk. In a preferred embodiment, information about a frequency of incorrect construction practices associated with a given checkpoint, an assessment of likelihood that incorrect construction will lead to a claim, and an estimated cost of repair may be used to select and to prioritize checkpoints according to a predicted level of financial risk that they pose to a builder if improperly installed. In other embodiments, as will be familiar to one of ordinary skill in the art, assessment of financial risk associated with the checkpoints may be implemented using other associated financial and legal information, at least some of which may be stored in the checkpoint repository 120. In a preferred embodiment, the checkpoint selection engine 140 uses the risk-based filter rules 223 to prioritize selected checkpoints for presentation to the inspector, so that checkpoints associated with a higher amount of potential financial risk may be presented earlier to an inspector conducting an inspection.

Project-based filter rules 224 may make use of scheduling information associated with a building project. Scheduling information may be provided by the builder as part of the initial information about the building project, and may define expected stages of construction for the project. Stages may be defined based on calendar dates (for example, WEEK 1, WEEK 2, etc.), based on major building system components (for example, “Initial Site Excavation,” “Foundation,” “Plumbing,” “Roofing,” etc.), or by another method that subdivides a project into smaller components. Scheduling information allows the checkpoint management system 100 to select and present to an inspector those checkpoints that are relevant to a current stage of construction, thereby serving to remind the inspector to examine the identified checkpoint construction elements during a window of opportunity while they are installed and still accessible. In some embodiments, the project-based filter rules 224 may be implemented as part of the checkpoint filter application 160 on an inspector's computer device 115. By allowing the inspector to supply real-time, observable, stage-of-completion information to the inspection application 150, the checkpoint filter application 160 on an inspector's computer device 115 may perform additional, dynamic filtering based on this information.

One or more additional filters 225 may also be implemented to select and/or prioritize construction checkpoints for the building project. For example, filters that select checkpoints particularly emphasized in local building codes, checkpoints that have been a source of recurring problems to a given builder, and/or checkpoints associated with unique and possibly problematic facets of the building project, such as complicated architectural features or specific products, may be desirable and may be offered by some embodiments of the system.

Rather than having each set of filter rules 221-225 select a set of checkpoints to include, a scoring algorithm may be used in which a relevance score is generated for each candidate checkpoint. The relevance score for a given checkpoint may take into consideration the relevance of the checkpoint under each set of rules 221-225, and may thus represent overall relevance or importance to the project. The N checkpoints with the highest scores (where N is a selected integer) may then be selected.

In some cases, it may be desirable to provide a degree of variability or randomness in the selection process so that the same set of inputs will not always result in selection of the same set of checkpoints. This may be accomplished, for example, by using a random selection algorithm in which the probability that a given checkpoint will be selected is proportional to its relevance score. Variability may also be provided by using different sets of checkpoints to inspect different buildings in the same project.

In various embodiments, the checkpoint selection engine 140 may utilize various types of data to make its selections. One type is based on simple, mostly static, data, such as building type, geographic location, products used, and the like. While certain of these elements, such as products being used, may change during a project's lifetime, for the most part, the changes are infrequent, and the checkpoint selection engine 140 responds accordingly, in a relatively predictable, linear fashion.

Another type of data is more dynamic and may include responses to questions such as: Which checkpoints have never or rarely been checked? Which checkpoints have repeatedly resulted in “unacceptable” ratings? Of the “unacceptable” checkpoints, which are more expensive to repair? What checkpoint failure “patterns” have been noticed by the system? In various embodiments, the checkpoint selection engine 140 is configured to “learn” from the foregoing types of historical data collection and automatically adjust prioritizations, or “recommendations” to a field inspector that directs the inspector to potential perceived problems.

A further type of data, identified as “dynamically seeded data” (DSD), selects specialized checkpoints stored by a prior input of special name brand, specific products or systems identified as a component with the building system. Yet another type of data checkpoint selection includes information and or history of the installing contractor, wherein a pattern of historical problems of a given component could trigger selection of additional checkpoints associated with that component.

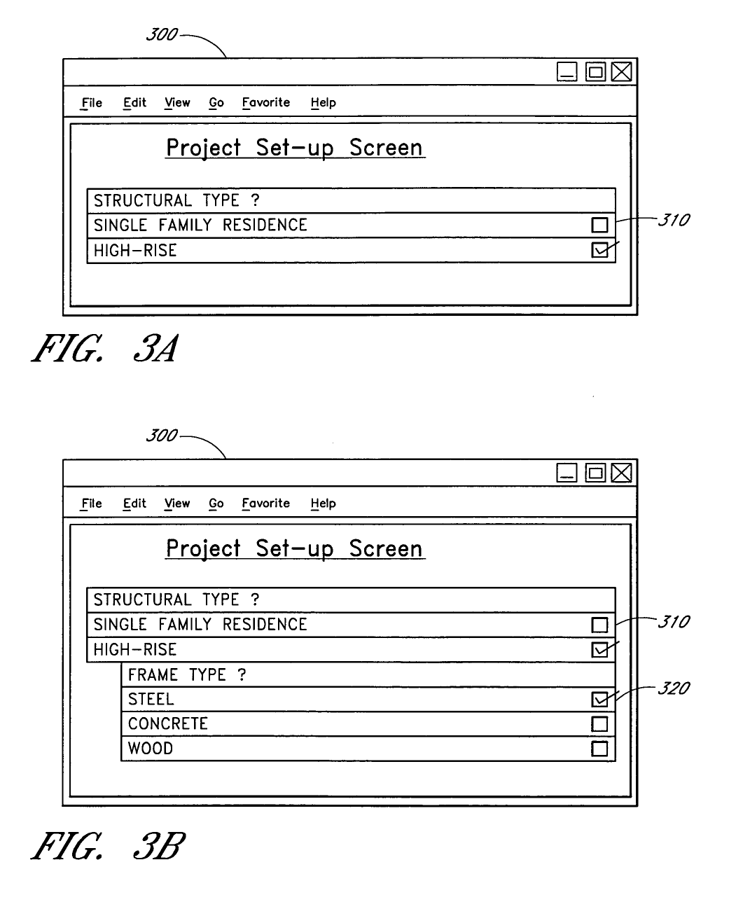

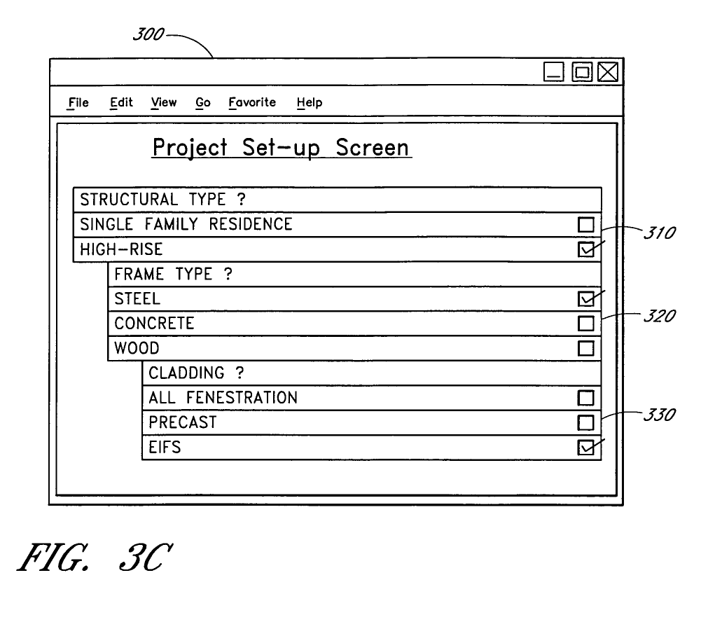

FIGS. 3A-3C depict views of a sample project set-up screen 300 that may be displayed on the builder computer 110 for obtaining project information from the builder. In the simplified version depicted, the builder may be prompted, via a drop-down menu, to enter information about the project that will allow the system to select checkpoints for the project. For example, the builder may be prompted to indicate a building type 310, such as single-family residence or high-rise. Based on the response to the first prompt, the builder may be further prompted to provide information about building materials to be used for the project, such as steel, concrete, or wood. Based on the building materials, the builder may be prompted to provide information about the cladding of the building. For example, if the project has been described as a high-rise with a steel structure, a drop-down menu may prompt the builder to indicate whether the exterior of the building will be made of glass, pre-cast concrete, or exterior insulating and finishing system (EIFS). Information entered by the builder may be stored in the construction project repository 130 and may be used for generating one or more sets of checkpoints relevant to the project.

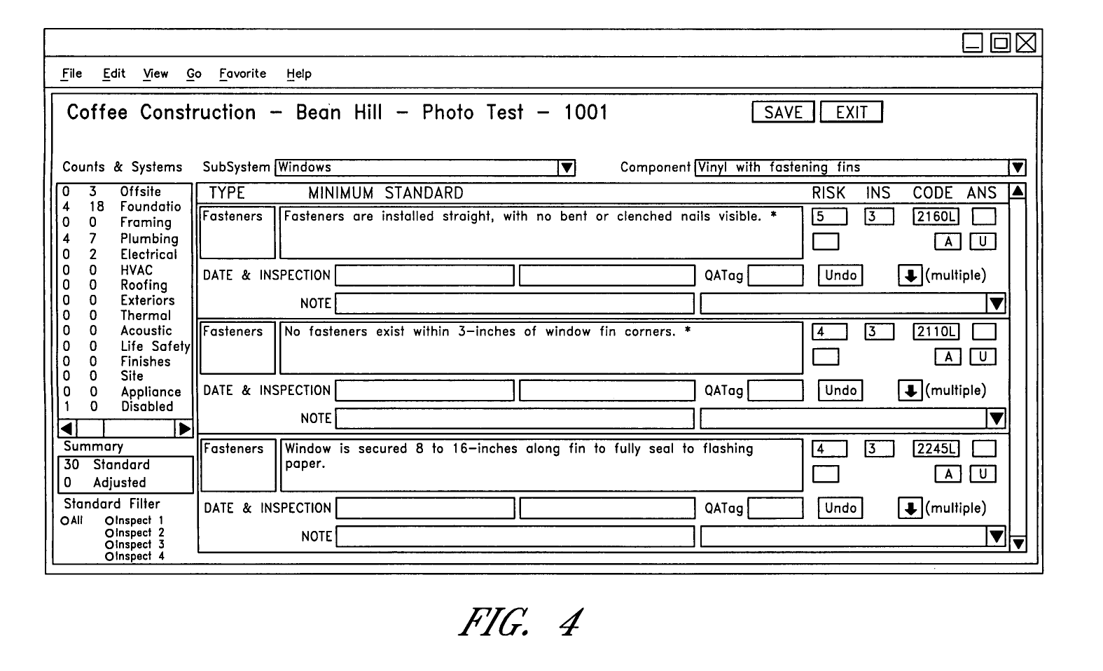

FIG. 4 depicts a first screenshot that displays selected construction checkpoints to a field inspector. In FIG. 4, the checkpoints have been selected for a Bean Hill building project of a company named Coffee Construction. Along the left-hand side of the screen, a count of checkpoints, grouped into systems, shows checkpoints currently selected for the building project as well as numbers of those that have already been inspected. For example, FIG. 4 shows a screenshot in which eighteen foundation-related checkpoints are available to the inspector, of which four have already been answered. A center portion of the screen presents the selected checkpoints to the inspector. In the example shown, the inspector is currently inspecting the windows system of the building project. Four checkpoints are presented, including three that relate to fasteners used with the window, and one that relates to flashing paper installed around the windows. A narrative describes a minimum standard of correct building practice associated with the checkpoint to be used by the inspector as a standard by which to determine whether the checkpoint element is acceptable or unacceptable. Two buttons, which may be radio-style buttons, on the right-hand side of the checkpoint section allow the inspector to designate the checkpoint as acceptable (denoted by “A”) or unacceptable (denoted by “U”). A button with a camera icon allows the inspector to photograph the checkpoint element using a camera built into the inspector computer device 115. Space may be provided for the inspector to self-identify, to enter the date of the inspection, and to add any applicable notes. In some applications, inspector identification and date information may be filled in automatically by the inspection application 150. Furthermore, information may be input by the inspector and/or automatically about the location of the inspection, one or more identifiers, such as a tag number or other identifier to further help physically identify a deficiency, and tie it to a record in the checkpoint repository 180.

Information input by the inspector may be stored in the inspection data repository of the inspector computer device 115 and/or may be passed to the checkpoint management system 100 for storage in the construction project repository 130 and for reporting to the builder.

In various embodiments, individual instances of checkpoint elements that have been designated as unacceptable are uniquely identified, tracked, and may be treated in a variety ways. A list of unacceptable checkpoints may be generated and provided to the builder for follow-up. The system may flag the unacceptable items as open items for the inspector to continue checking until the checkpoint passes inspection.

One or more reports that summarize inspection results may be made available as a hard copy, for example printed by the field inspector, and/or as an online report that may be made available by the checkpoint management system 100 once the inspector has transmitted inspection data to the checkpoint management system 100. In other embodiments, the inspector computer device 115 may be configured to transmit email reports directly to the builder, especially regarding unacceptable checkpoint elements that were identified during an inspection. In some embodiments, specific trade-sorted open items may be electronically distributed to installers and vendors to alert them of problems associated with their work.

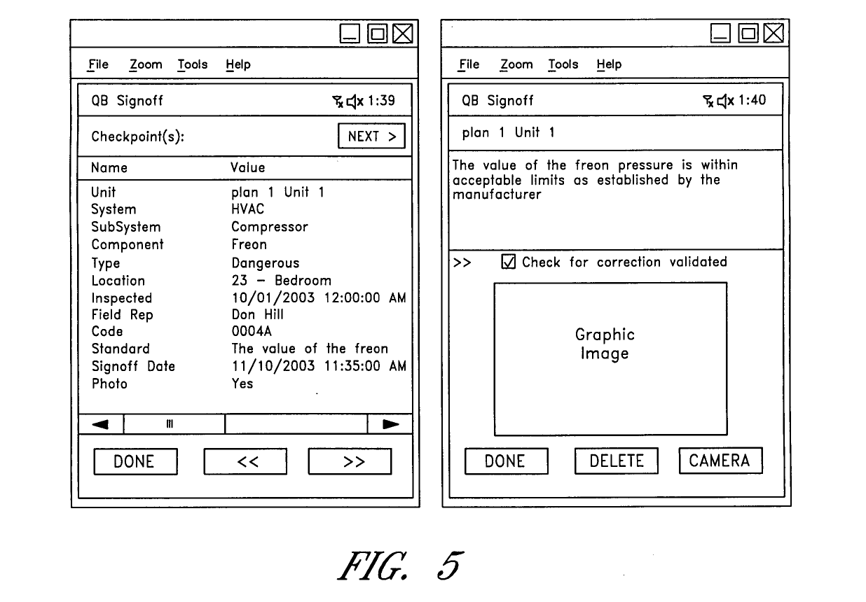

FIG. 5 depicts a screenshot that displays a construction checkpoint element that has been designated as unacceptable for viewing by a field supervisor, superintendent, project manager, or other party for insuring that the checkpoint element is corrected. In one embodiment, the field supervisor uses a hand-held computer device such as a personal digital assistant (PDA) that is configured to receive wireless communications from the checkpoint management system 100. The checkpoint management system 100 may transmit information about currently unacceptable checkpoint elements to the field supervisor. The example depicted in the PDA screenshot of FIG. 5 identifies the checkpoint, when it was inspected and by whom, and again provides a description of proper construction technique associated with the checkpoint in order to provide a standard against which the checkpoint may be inspected. When the field supervisor observes that the checkpoint has been corrected, the field supervisor may sign off on the checkpoint and may use a camera built into the PDA, if available, to photograph the corrected checkpoint for verification. In some embodiments, the PDA may transmit a wireless communication to the checkpoint management system 100 indicating closure of the open item.

FIG. 6 is a flowchart that depicts a high-level overview of one embodiment of a process 600 to select construction checkpoints. Initially, as depicted by Block 610, the system receives project set-up information. As described above, project set-up information may include information such as: size and site of the project, any special environmental exposures to which the project is subject, types of structures and construction methods for the project, specific building materials to be used in the project, and projected construction schedule of the project. In other embodiments, other information may additionally or alternatively be received from the builder. For example, the additional information may include information about the builder, the builder's experience with similar projects, the builder's past history of construction defect claims, information about local building code authorities, and any unusual or complex aspects of the building project design that may warrant special attention.

In Block 620, based on the project set-up information received in Block 610, the system may determine a construction schedule and milestone stages for the building project so that checkpoints may be presented to the inspector at times appropriate to installation and inspection of the checkpoint.

In Block 630, the system applies filters. As was described in greater detail with reference to FIG. 2, filters may select and/or prioritize checkpoints based on climatic exposure of the building project, other environmental exposure(s) of the project, risk associated with installing and/or constructing the checkpoint, construction schedule of the project, and/or other bases.

In Block 640, after the applicable filters have been applied, the system presents the selected checkpoints for viewing by an inspector or other interested party. As has been described above, the set of selected checkpoints or a subset thereof may be transmitted or otherwise passed to an inspector computer device 115 for viewing by a building inspector. In some embodiments, additional filters may be applied to the checkpoints on the inspector computer device 115. Furthermore, a paper version of the list of checkpoints may additionally or alternatively be printed.

FIG. 6 presents a high-level view of one embodiment of a computerized process to select and/or prioritize construction checkpoints using filter rules. In other embodiments, selection and/or prioritization may be implemented using an expert system, decision tree, probabilistic reasoning, statistical weighting, or other computer methodology that uses information about a building project to identify construction checkpoints, such as checkpoints representing a higher level of potential financial risk for the building project. Furthermore, in other embodiments, the functions carried out in the blocks of FIG. 6 may be implemented in a different order or the functions may be executed iteratively, with different portions of the selection and presentation of checkpoints being carried out at different stages of the process. Additionally, machine learning may be introduced to the system, either fully automated, or human-assisted, so that information gained from inspections, from news of litigation, from industry, from insurance companies, and from other sources, may be used in a type of feedback loop that allows for intelligent updating of checkpoint records and/or filter rules or other selection mechanisms. These and other variations will be familiar to a practitioner of ordinary skill in the art of computer information retrieval and may be implemented without undue experimentation on the part of the practitioner.

Although the foregoing systems and methods have been described in terms of certain preferred embodiments, other embodiments will be apparent to those of ordinary skill in the art from the disclosure herein. Additionally, other combinations, omissions, substitutions and modifications will be apparent to the skilled artisan in view of the disclosure herein. While certain embodiments of the inventions have been described, these embodiments have been presented by way of example only, and are not intended to limit the scope of the inventions. Indeed, the novel methods and systems described herein may be embodied in a variety of other forms without departing from the spirit thereof. The accompanying claims and their equivalents are intended to cover such forms or modifications as would fall within the scope and spirit of the invention.

What is claimed is:

1. In a computer system that implements a repository of construction checkpoints, a method of selecting a subset of the construction checkpoints for guiding an inspection associated with constructing a building project, the method comprising the computer-implemented steps of:
(a) receiving information about a building project;
(b) filtering records in a repository of construction checkpoints such that a subset of construction checkpoints relevant for conducting an inspection associated with constructing the building project are selected, based at least in part on the information about the building project; and
(c) presenting at least some of the selected construction checkpoints for use in guiding an inspection of the building project.

2. The method of claim 1, wherein step (a) comprises receiving information about: type of structure being constructed, construction materials being used, and environmental region in which the building project is being constructed.

3. The method of claim 2, wherein step (a) comprises receiving information from a builder.

4. The method of claim 1, wherein step (a) comprises receiving information from an inspector of the building project.

5. The method of claim 1, wherein step (b) comprises filtering the records based at least in part on information about a type of structure being constructed.

6. The method of claim 1, wherein step (b) comprises filtering the records based at least in part on information about a geographical region in which the building project is being constructed.

7. The method of claim 1, wherein step (b) comprises filtering the records based at least in part on information about environmental conditions to which the building project will be exposed.

8. The method of claim 7, wherein the environmental conditions include at least one of: earthquakes, floods, firestorms, temperature extremes, high humidity, tornadoes, sandstorms, and hurricanes.

9. The method of claim 1, wherein step (b) comprises filtering the records based at least in part on information about an historical frequency of failure associated with inspections of the checkpoint elements.

10. The method of claim 9, wherein step (b) further comprises filtering the records based at least in part on information about a frequency of past failures associated with a builder of the building project.

11. The method of claim 9, wherein step (b) further comprises filtering the records based at least in part on information about a frequency of past failures associated with products used in the building project.

12. The method of claim 9, wherein step (b) further comprises filtering the records based at least in part on information about a frequency of past failures associated with unique facets of construction associated with the building project.

13. The method of claim 1, wherein step (b) comprises filtering the records based at least in part on information about costs for repairs associated with the construction checkpoints.

14. The method of claim 13, wherein step (b) comprises filtering the records based at least in part on information about financial risk associated with poor construction of the construction elements associated with the construction checkpoints.

15. The method of claim 13, wherein step (c) comprises presenting the selected construction checkpoints in an ordered list.

16. The method of claim 15, wherein presenting the selected construction checkpoints in an ordered list comprises ordering the list according to the potential costs for repairs associated with the selected construction checkpoints.

17. The method of claim 1, wherein step (a) comprises receiving scheduling information about stages of construction associated with the building project, step (b) comprises filtering the records based at least in part on information about stages of construction with which the construction checkpoints are associated, and step (c) comprises presenting construction checkpoints associated with a current stage of construction.

18. The method of claim 1, wherein the checkpoints are selected to guide an inspection for reducing construction failure or financial risk associated with building the project.

19. A computer-implemented construction checkpoint selection system, comprising:
a user interface for accepting information about a building project;
a repository of construction checkpoints; and
a checkpoint selection application configured to receive the information about the building project and to use the information to select from the repository a subset of the construction checkpoints for use in inspecting the building project.

20. The system of claim 19, wherein the repository of construction checkpoints comprises records for individual checkpoints, and wherein a record comprises information about proper construction techniques associated with the checkpoint, one or more building types for which the checkpoint is important to inspect, one or more environmental regions in which the checkpoint is important to inspect, and information useful for determining a level of financial risk associated with improper construction techniques associated with the checkpoint.

21. The system of claim 19, further comprising a remote communications interface configured to transmit at least a subset of the selected checkpoints to a remote computer device.

22. The system of claim 21, wherein the remote computer is configured to present at least one checkpoint to a user and to receive from the user input indicative of whether the checkpoint has passed or failed an inspection.

23. The system of claim 21, wherein the remote communications interface is further configured to receive information from the remote computer about results of an inspection based on the transmitted checkpoints.

24. A system for selecting from a computer-stored repository of construction checkpoints a subset of the checkpoints for guiding an inspection to minimize financial risk associated with constructing a building project, the system comprising:
means for receiving from a builder information about a building project;
means for filtering records in a repository of construction checkpoints such that a subset of construction checkpoints relevant for reducing financial risk associated with constructing the building project may be selected, based at least in part on the information about the building project; and
means for presenting at least some of the selected construction checkpoints for use in guiding an inspection of the building project.

25. A computer-implemented method of increasing an effectiveness of building inspections, comprising:
receiving data descriptive of a building project for which one or more inspections are to be performed, including information about a geographic region of the building project, a current stage of the building project, and types of construction materials used; and
programmatically selecting, from a repository of construction checkpoints, a subset of construction checkpoints to use to conduct an inspection associated with the building project, such that the subset of checkpoints is selected based at least in part on the information about the geographic region of the building project, the current stage of the building project, and the types of construction materials used.

26. The method of claim 25, wherein receiving data descriptive of a building project comprises receiving the data from a builder computer.

27. The method of claim 25, wherein receiving data descriptive of a building project comprises receiving, on a portable computing device, information entered by an inspector about the current stage of the building project.

28. The method of claim 27, further comprising outputting the subset of checkpoints to the inspector on the portable computing device.

29. The method of claim 25, wherein the subset of checkpoints is selected by a central computer system, and the method further comprises transmitting a list of the subset of checkpoints to a portable inspection computing device that is adapted to be used by an inspector during an inspection process.

30. The method of claim 25, wherein the subset of construction checkpoints is selected in part by a central computer system based on project information specified by a builder, and in part by a portable computing device based on information specified on-site by builder, and in part by a portable computing device based on information specified on-site by an inspector.

31. The method of claim 25, wherein programmatically selecting the subset of construction checkpoints comprises executing a scoring algorithm that assigns scores to candidate checkpoints and using the scores to select specific checkpoints.
